(19) United States
(12) Patent Application Publication
(10) Pub. No.: US 2010/0183871 A1
(43) Pub. Date: Jul. 22, 2010

(54) NONCONDUCTIVE SURFACE METALLIZATION METHOD AND PLASTIC ARTICLE MANUFACTURED BY THE SAME

(75) Inventors: WAN-CHUN PENG, Shenzhen City (CN); GANG XIONG, Shenzhen City (CN); CHWAN-HWA CHIANG, Shindian (TW); CHUN-MAN HON, Shindian (TW); FENG-YUEN DAI, Shindian (TW)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/561,369

(22) Filed: Sep. 17, 2009

(30) Foreign Application Priority Data
Jan. 16, 2009 (CN) 200910300243.6

(51) Int. Cl. B32B 15/08; B05D 3/00

(52) U.S. Cl. 428/336; 427/296; 428/457

(57) ABSTRACT

A nonconductive surface metallization method of plastic substrate comprising: providing a plastic substrate; and forming a black-colored and nonconductive alloy coating on the plastic substrate surface by a vacuum evaporating process, the alloy coating being formed by a target comprising a first material and a second material, the first material being a steel, the second material being selected from a group consisting of indium, tin, aluminium and silicon dioxide. A plastic article has a black-colored and nonconductive alloy coating is provided in the present disclosure.

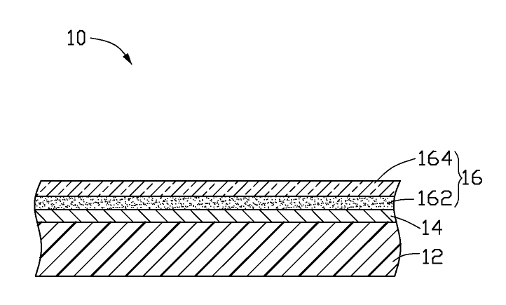

### BACKGROUND

1. Technical Field

The present disclosure relates to a nonconductive surface metallization method for plastics and a plastic article manufactured by the nonconductive surface metallization method.

2. Description of Related Art

Vacuum coating, such as vacuum sputtering and vacuum evaporating, is widely used for coating housings of electronic devices and environmentally friendly. Plastic housings can be vacuum coated to achieve a glossy metallic surface appearance, therebys improving exterior appearance.

However, on communication devices, the metallic coatings on the casings using typical vacuum coating process may be electrically conductive, which may affect the transmission quality of the communication devices. Although targets for vacuum evaporation coating made of titanium or tin may be used to form nonconductive coating on the housings, such nonconductive coating can only present a generally silver or grayish color.

Therefore, there is room for improvement within the art.

### BRIEF DESCRIPTION OF THE DRAWING

Many aspects of the plastic article can be better understood with reference to the following drawing. The components in the drawing are not necessarily to scale, the emphasis instead being placed upon clearly illustrating the principles of the present plastic article. Moreover, in the drawing, like reference numerals designate corresponding parts throughout the following view.

The FIGURE is a cross-section view of a plastic article according to an exemplary embodiment.

### DETAILED DESCRIPTION OF THE EXEMPLARY EMBODIMENT

The FIGURE shows an exemplary plastic article 10 made according to an exemplary nonconductive surface metallization method including at least the following steps.

A plastic substrate 12 is provided.

The plastic substrate 12 is pre-treated by degreasing the surface of the plastic substrate 12 with a cleaning solution containing organic solvent (e.g., ethanol and isopropyl alcohol) to remove any oil stains on the plastic substrate 12.

A black-colored and nonconductive alloy coating 14 is formed on the surface of the plastic substrate 12 by a vacuum evaporating process. To ensure the alloy coating 14 is black-colored and nonconductive, two materials, such as a combination of a first material and a second material are selected as the target. The first material can be a steel, such as stainless steel. The second material may be selected from a group consisting of indium, tin, aluminium and silicon dioxide. The thickness of the alloy coating 14 may be about 0.005-1000 nm. In this exemplary embodiment, the alloy coating 14 has a thickness of about 10-500 nm. The weight ratio of the first material contained in the target should be less than the weight ratio of the second material contained in the target. The weight ratio of the first material may be about 50-95%, and the weight ratio of the second material may be about 5-50%.

A transparent protective coating 16 is formed on the alloy coating 14 by spray painting. The protective coating 16 may include a middle paint layer 162 and a top paint layer 164. The middle paint layer 162 is transparent and may be black-colored or colorless. The middle paint layer 162 may be formed by an ultraviolet curing paint or a hot curing paint (e.g., polyurethane paint and unsaturated polyester paint). The middle paint layer 162 can improve bonding between the top paint layer 164 and the substrate. The top paint layer 164 is provided with rigidity to protect the substrate surface. The top paint layer 164 may be made by a transparent ultraviolet curing paint.

The plastic article 10 made by the method as described above includes a plastic substrate 12, a black-colored and nonconductive alloy coating 14 on the surface of the plastic substrate 12, and a transparent protective coating 16 formed on the alloy coating 14. The plated metal coating 14 contains a first material and a second material. The first material can be a steel, such as stainless steel. The second material may be selected from a group consisting of indium, tin, aluminium and silicon dioxide. The protective coating 16 includes the middle paint layer 162 and the top paint layer 164.

It should be understood that to improve the smoothness of the surface of the plastic substrate 12 and achieve a glossy alloy coating 14, the nonconductive surface metallization method may further include a step of forming a base paint layer on the plastic substrate surface before the forming of the alloy coating.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A nonconductive surface metallization method of plastic substrate comprising:
providing a plastic substrate;
forming a black-colored and nonconductive alloy coating on the plastic substrate surface by a vacuum evaporating process, the alloy coating being formed by a target comprising a first material and a second material, the first material being a steel, the second material being selected from a group consisting of indium, tin, aluminium and silicon dioxide.

2. The nonconductive surface metallization method of plastic substrate as claimed in claim 1, wherein the thickness of the alloy coating is about 0.005-1000 nm.

3. The nonconductive surface metallization method of plastic substrate as claimed in claim 2, wherein the thickness of the alloy coating is about 10-500 nm.

4. The nonconductive surface metallization method of plastic substrate as claimed in claim 3, wherein the weight ratio of the first material of the target is less than the weight ratio of the second material of the target.

5. The nonconductive surface metallization method of plastic substrate as claimed in claim 4, wherein weight ratio of the first material is about 50-95% and the weight ratio of the second material is about 5-50%.

6. The nonconductive surface metallization method of plastic substrate as claimed in claim 1, further comprising forming a transparent protective coating on the surface of the alloy coating.

7. The nonconductive surface metallization method of plastic substrate as claimed in claim 6, wherein the protective coating includes a middle paint layer and a top paint layer.

8. The nonconductive surface metallization method of plastic substrate as claimed in claim 1, further comprising a step of forming a base paint layer on the plastic substrate surface before forming the alloy coating.

9. The nonconductive surface metallization method of plastic substrate as claimed in claim 1, wherein the steel is a stainless steel.

10. A plastic article, comprising:
a plastic substrate; and
a black-colored and nonconductive alloy coating formed on the plastic substrate surface, the alloy coating containing a first material and a second material, the first material being a steel, the second material being selected from a group consisting of indium, tin, aluminium and silicon dioxide.

11. The plastic article as claimed in claim 10, wherein the alloy coating has a thickness of about 0.005-1000 nm.

12. The plastic article as claimed in claim 11, wherein the plastic article further comprising a transparent protective coating on the surface of the alloy coating.

13. The plastic article as claimed in claim 11, wherein the protective coating includes a middle paint layer and a top paint layer.

14. The plastic article as claimed in claim 11, wherein the steel is a stainless steel.
